(19) United States
(12) Patent Application Publication
(10) Pub. No.: US 2016/0374051 A1
(43) Pub. Date: Dec. 22, 2016

(54) MOBILE COMMUNICATION SYSTEM AND USER TERMINAL

(71) Applicant: KYOCERA CORPORATION, Kyoto-shi (JP)

(72) Inventor: Kugo MORITA, Yokohama-shi (JP)

(73) Assignee: KYOCERA CORPORATION, Kyoto (JP)

(21) Appl. No.: 14/901,796

(22) PCT Filed: Jul. 7, 2014
(86) PCT No.: PCT/JP2014/068008

§ 371 Date: Dec. 29, 2015

(30) Foreign Application Priority Data
Jul. 9, 2013 (JP) 2013-144023

(51) Int. Cl. H04W 72/02; H04W 72/12; H04W 76/02

(52) U.S. Cl. CPC H04W 72/02; H04W 76/023; H04W 72/12; H04W 92/18

(57) ABSTRACT

In a case where each of the plurality of other user terminals establishes connection for user data with a user terminal for transmitting and receiving user data through D2D communication without establishing the connection for user data with each of the plurality of other user terminals, a scheduling terminal is selected from the user terminal and the plurality of other user terminals, the scheduling terminal allocating, to each of the user terminal and the plurality of other user terminals, a mutually different radio resource in order to transmit data including the user data, and the scheduling terminal broadcasts scheduling information that indicates the radio resource allocated to each of the user terminal and the plurality of other user terminals, using a radio resource that has been shared with the plurality of other terminals.

### TECHNICAL FIELD

The present invention relates to a mobile communication system and a user terminal that support D2D communication.

### BACKGROUND ART

The 3rd Generation Partnership Project (3GPP), which is a standardization project for mobile communication systems, has examined introduction of terminal-to-terminal (Device to Device: D2D) communication as a new feature since Release 12 (refer to Non Patent Document 1).

In the D2D communication, a plurality of user terminals adjacent to each other performs direct terminal-to-terminal communication without passing through a network. Meanwhile, in cellular communication, which is typical for mobile communication systems, a user terminal performs communication through the network.

In addition to a case where a base station included in the network initiatively performs scheduling that allocates a radio resource used for transmitting and receiving user data in the D2D communication, a case where a user terminal that performs the D2D communication initiatively performs the scheduling, is envisaged. The user terminal itself that performs the D2D communication allocates the radio resource so that a load of the base station can be reduced.

### PRIOR ART DOCUMENT

### Non-Patent Document

Non Patent Document 1: 3GPP Specification Status Report “TR 22.803 V12.1.0” March, 2013

### SUMMARY OF THE INVENTION

As a case where one user terminal performs D2D communication with a plurality of other user terminals as targets, in addition to a case where all members of a group including the one user terminal and the plurality of other user terminals perform the D2D communication, a case where the one user terminal individually performs the D2D communication with each of the plurality of other user terminals, in other words, a case where transmission of user data is not performed through the D2D communication between the plurality of other user terminals, are envisaged.

In the latter case, when, instead of the one user terminal, each of the plurality of other user terminals performs scheduling of a radio resource to be allocated to oneself and the one user terminal in order to transmit user data, since each of the plurality of other user terminals has no information on a status of radio resources that have been allocated to the remaining other user terminal(s) except oneself, there is a possibility that the plurality of other user terminals allocates mutually the same radio resource. In a case where each of the plurality of other user terminals performs the D2D communication using mutually the same radio resource, there is a risk that interference occurs.

An object of the present invention is to provide a mobile communication system and a user terminal capable of inhibiting occurrence of interference in a case where a user terminal individually performs the D2D communication with each of a plurality of other user terminals.

A mobile communication system according to an embodiment is a mobile communication system comprising a user terminal and a plurality of other user terminals different from the user terminal and supporting D2D communication that is direct terminal-to-terminal communication without passing through a network. In a case where each of the plurality of other user terminals establishes connection for user data with the user terminal for transmitting and receiving user data through the D2D communication without establishing the connection for user data with each of the plurality of other user terminals, a scheduling terminal is selected from the user terminal and the plurality of other user terminals, the scheduling terminal allocating, to each of the user terminal and the plurality of other user terminals, a mutually different radio resource in order to transmit data including the user data, and the scheduling terminal broadcasts scheduling information that indicates the radio resource allocated to each of the user terminal and the plurality of other user terminals, using a radio resource that has been shared with the plurality of other terminals.

According to the mobile communication system and the user terminal according to the present invention, it is possible to inhibit occurrence of interference in a case where a user terminal individually performs the D2D communication with each of a plurality of other user terminals.

### BRIEF DESCRIPTION OF THE DRAWINGS

FIG. 1 is a diagram of a configuration of an LTE system.

FIG. 2 is a block diagram of UE.

FIG. 3 is a block diagram of an eNB.

FIG. 4 is a protocol stack diagram of a radio interface in the LTE system.

FIG. 5 is a diagram of a configuration of a radio frame used in the LTE system.

FIG. 6 is a diagram showing a data path in D2D communication.

FIG. 7 is an explanatory diagram for describing a state where each of UEs 100 has performed the D2D communication.

FIG. 8 is an explanatory diagram for describing a state where the UE 100-1 has broadcasted a radio resource allocated to each of the UEs 100 (band allocation).

FIG. 9 is a sequence diagram illustrating exemplary operation of a mobile communication system according to the present embodiment.

FIG. 10 is a sequence diagram illustrating exemplary operation of a mobile communication system according to a first modification of the present embodiment.

FIG. 11 is a sequence diagram illustrating other exemplary operation of the mobile communication system according to the first modification of the present embodiment.

FIG. 12 is an explanatory diagram for describing a state where the UE 100-2 according to a second modification of the present embodiment has broadcasted a radio resource allocated to each UEs 100 (band allocation).

FIG. 13 is a sequence diagram illustrating exemplary operation of a mobile communication system according to the second modification of the present embodiment.

### DESCRIPTION OF THE EMBODIMENT

### Overview of Embodiment

A mobile communication system according to the embodiment is a mobile communication system comprising a user terminal and a plurality of other user terminals different from the user terminal and supporting D2D communication that is direct terminal-to-terminal communication without passing through a network. In a case where each of the plurality of other user terminals establishes connection for user data with the user terminal for transmitting and receiving user data through the D2D communication without establishing the connection for user data with each of the plurality of other user terminals, a scheduling terminal is selected from the user terminal and the plurality of other user terminals, the scheduling terminal allocating, to each of the user terminal and the plurality of other user terminals, a mutually different radio resource in order to transmit data including the user data, and the scheduling terminal broadcasts scheduling information that indicates the radio resource allocated to each of the user terminal and the plurality of other user terminals, using a radio resource that has been shared with the plurality of other terminals.

In the second modification according to the embodiment, the scheduling terminal is selected from the plurality of other user terminals, and the scheduling terminal establishes connection for broadcasting the scheduling information, with each of the plurality of other user terminals except the scheduling terminal.

In the second modification according to the embodiment, each of the plurality of other user terminals transmits, to the user terminal, capability information on scheduling capability for allocating the radio resource for the D2D communication, and the scheduling terminal is selected based on the capability information.

In the second modification according to the embodiment, the scheduling terminal is newly selected from the user terminal and the plurality of other user terminals in a case where a predetermined condition is satisfied.

In the second modification according to the embodiment, the predetermined condition is that remaining battery power of the scheduling terminal becomes below a threshold value.

In the embodiment, each of the plurality of other user terminals transmits and receives the user data, based on the scheduling information, using an encryption key for encrypting the user data and a decryption key for decrypting the user data that has been encrypted using the encryption key.

A user terminal according to the embodiment is a user terminal in a mobile communication system comprising the user terminal and a plurality of other user terminals different from the user terminal and supporting D2D communication that is direct terminal-to-terminal communication without passing through a network. The user terminal comprises: a controller configured to allocate, to each of the user terminal and the plurality of other user terminals, a mutually different radio resource in order to transmit data including user data in a case where each of the plurality of other user terminals establishes connection for user data with the user terminal for transmitting and receiving the user data through the D2D communication without establishing the connection for user data with each of the plurality of other user terminals; and a transmitter configured to broadcast scheduling information indicating the radio resource allocated to each of the plurality of other user terminals, using a radio resource that has been shared with the plurality of other user terminals.

A user terminal according to the embodiment is a user terminal in a mobile communication system comprising a user terminal, a different user terminal that is the communicating target, and a plurality of other user terminals different from the user terminal and the different user terminal, and supporting D2D communication that is direct terminal-to terminal communication without passing through a network. The user terminal comprises: a controller configured to allocate, to each of the user terminal, the different user terminal, and the plurality of other user terminals, a mutually different radio resource in order to transmit data including user data, in a case where the user terminal establishes connection for user data with the different user terminal for transmitting and receiving the user data through the D2D communication without establishing the connection for user data with each of the plurality of other terminals, and a transmitter configured to broadcast scheduling information indicating the radio resource allocated to each of the different user terminal and the plurality of other user terminals using a radio resource that has been shared with the different user terminal and the plurality of other user terminals.

Hereinafter, with reference to the accompanying drawings, the following description will be provided for each embodiment when D2D communication is introduced to a cellular mobile communication system (hereinafter, an “LTE system”) configured according to 3GPP standards.

### Embodiment

### LTE System

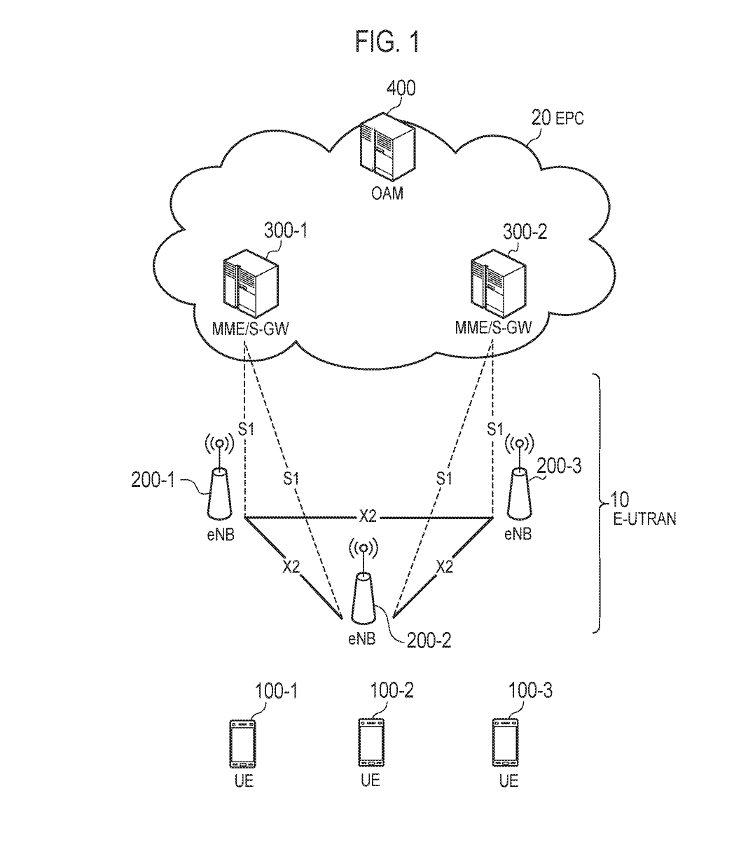

FIG. 1 is a configuration diagram of the LTE system according to the present embodiment.

As illustrated in FIG. 1, the LTE system includes a plurality of UEs (User Equipments) 100, E-UTRAN (Evolved Universal Terrestrial Radio Access Network) 10, and EPC (Evolved Packet Core) 20. The E-UTRAN 10 and the EPC 20 constitute a network.

The UE 100 is a mobile radio communication device and performs radio communication with a cell (a serving cell) with which a connection is established. The UE 100 corresponds to the user terminal.

The E-UTRAN 10 includes a plurality of eNBs 200 (evolved Node-Bs). The eNB 200 corresponds to a base station. The eNB 200 manages a cell and performs radio communication with the UE 100 which establishes a connection with the cell.

It is noted that the “cell” is used as a term indicating a minimum unit of a radio communication area, and is also used as a term indicating a function of performing radio communication with the UE 100.

The eNB 200, for example, has a radio resource management (RRM) function, a routing function of user data, and a measurement control function for mobility control and scheduling.

The EPC 20 includes a MME (Mobility Management Entity)/S-GW (Serving-Gateway) 300 and an OAM 400 (Operation and Maintenance). Further, the EPC 20 corresponds to a core network.

The MME is a network node for performing various mobility controls for the UE 100, for example, and corresponds to a controller. The S-GW is a network node that performs transfer control of user data and corresponds to a mobile switching center.

The eNBs 200 are connected mutually via an X2 interface. Furthermore, the eNB 200 is connected to the MME/S-GW 300 via an S1 interface.

The OAM 400 is a server apparatus managed by an operator and performs maintenance and monitoring of the E-UTRAN 10.

Next, the configurations of the UE 100 and the eNB 200 will be described.

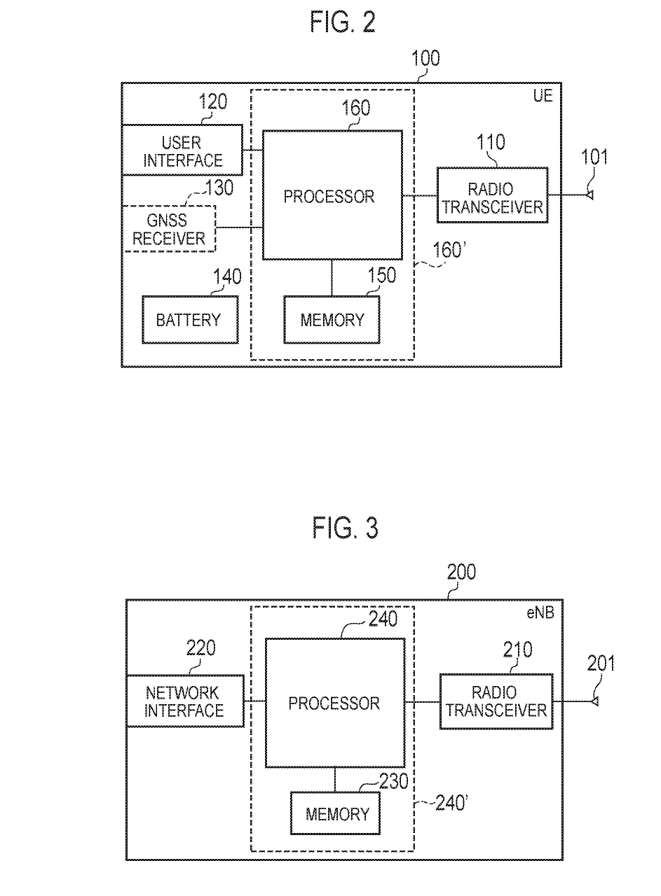

FIG. 2 is a block diagram of the UE 100. As illustrated in FIG. 2, the UE 100 includes an antenna 101, a radio transceiver 110, a user interface 120, a GNSS (Global Navigation Satellite System) receiver 130, a battery 140, a memory 150, and a processor 160. The memory 150 and the processor 160 constitute a controller.

In the present embodiment, the controller controls allocating mutually different radio resources to each UE 100.

The UE 100 may not have the GNSS receiver 130. Furthermore, the memory 150 may be integrally formed with the processor 160, and this set (that is, a chipset) may be called a processor 160′ constituting a controller.

The antenna 101 and the radio transceiver 110 are used to transmit and receive a radio signal. The antenna 101 includes a plurality of antenna elements. The radio transceiver 110 converts a baseband signal output from the processor 160 into the radio signal, and transmits the radio signal from the antenna 101. Furthermore, the radio transceiver 110 converts the radio signal received by the antenna 101 into the baseband signal, and outputs the baseband signal to the processor 160.

The user interface 120 is an interface with a user carrying the UE 100, and includes, for example, a display, a microphone, a speaker, and various buttons. The user interface 120 receives an operation from a user and outputs a signal indicating the content of the operation to the processor 160.

The GNSS receiver 130 receives a GNSS signal in order to obtain location information indicating a geographical location of the UE 100, and outputs the received signal to the processor 160.

The battery 140 accumulates a power to be supplied to each block of the UE 100.

The memory 150 stores a program to be executed by the processor 160 and information to be used for a process by the processor 160.

The processor 160 includes a baseband processor that performs modulation and demodulation, encoding and decoding and the like of the baseband signal, and a CPU (Central Processing Unit) that performs various processes by executing the program stored in the memory 150. The processor 160 may further include a codec that performs coding and decoding of sound and video signals. The processor 160 implements various processes and various communication protocols described later.

FIG. 3 is a block diagram of the eNB 200. As illustrated in FIG. 3, the eNB 200 includes an antenna 201, a radio transceiver 210, a network interface 220, a memory 230, and a processor 240. The memory 230 and the processor 240 constitute a controller. It is noted that the memory 230 may be integrally formed with the processor 240, and this set (that is, a chipset) may be called a processor 240′ constituting a controller.

The antenna 201 and the radio transceiver 210 are used to transmit and receive a radio signal. The antenna 201 includes a plurality of antenna elements. The radio transceiver 210 converts the baseband signal output from the processor 240 into the radio signal, and transmits the radio signal from the antenna 201. Furthermore, the radio transceiver 210 converts the radio signal received by the antenna 201 into the baseband signal, and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240.

The processor 240 includes the baseband processor that performs modulation and demodulation, encoding and decoding and the like of the baseband signal and a CPU that performs various processes by executing the program stored in the memory 230. The processor 240 implements various processes and various communication protocols described later.

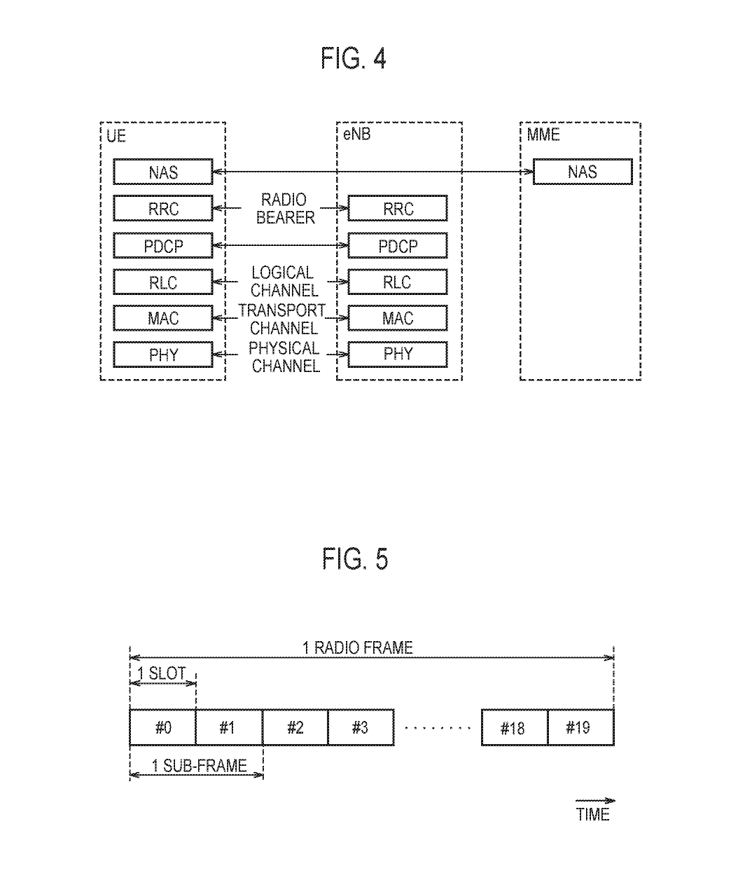

FIG. 4 is a protocol stack diagram of a radio interface in the LTE system.

As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. The PHY layer provides a transmission service to an upper layer by use of a physical channel. Between the PHY layer of the UE 100 and the PHY layer of the eNB 200, data is transmitted via the physical channel.

The MAC layer performs preferential control of data, and a retransmission process and the like by hybrid ARQ (an HARQ). Between the MAC layer of the UE 100 and the MAC layer of the eNB 200, data is transmitted via a transport channel. The MAC layer of the eNB 200 includes a MAC scheduler that determines an uplink and downlink transport format (a transport block size, a modulation and coding scheme and the like) and an assignment resource block.

The RLC layer transmits data to an RLC layer of a reception side by using the functions of the MAC layer and the PHY layer. Between the RLC layer of the UE 100 and the RLC layer of the eNB 200, data is transmitted via a logical channel.

The PDCP layer performs header compression and decompression, and encryption and decryption.

The RRC layer is defined only in a control plane. Between the RRC layer of the UE 100 and the RRC layer of the eNB 200, a control signal (an RRC message) for various types of setting is transmitted. The RRC layer controls the logical channel, the transport channel, and the physical channel in response to establishment, re-establishment, and release of a radio bearer. When an RRC connection is established between the RRC of the UE 100 and the RRC of the eNB 200, the UE 100 is in a connection state, and when the RRC connection is not established, the UE 100 is in an idle state.

A NAS (Non-Access Stratum) layer positioned above the RRC layer performs session management or mobility management, for example.

FIG. 5 is a configuration diagram of a radio frame used in the LTE system. In the LTE system, OFDMA (Orthogonal Frequency Division Multiplexing Access) is used in a downlink, and SC-FDMA (Single Carrier Frequency Division Multiple Access) is used in an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each symbol is provided at a head thereof with a guard interval called a cyclic prefix (CP). The resource block includes a plurality of subcarriers in the frequency direction. A radio resource unit configured by one subcarrier and one symbol is called a resource element (RE).

Among radio resources assigned to the UE 100, a frequency resource can be designated by a resource block and a time resource can be designated by a subframe (or slot).

In the downlink, an interval of several symbols at the head of each subframe is a control region mainly used as a physical downlink control channel (PDCCH). Furthermore, the other interval of each subframe is a region mainly used as a physical downlink shared channel (PDSCH). Furthermore, cell-specific reference signals (CRSs) are distributed and arranged in each subframe.

In the uplink, both end portions in the frequency direction of each subframe are control regions mainly used as a physical uplink control channel (PUCCH). Furthermore, the center portion, in the frequency direction, of each subframe is a region mainly used as a physical uplink shared channel (PUSCH). Furthermore, demodulation reference signal (DMRS) and sounding reference signal are arranged in each subframe.

(D2D Communication)

An LTE system according to the present embodiment supports D2D communication that is direct device-to-device communication (UE-to-UE communication). Here, the D2D communication is described in comparison with cellular communication that is normal communication of the LTE system. The cellular communication is a communication mode in which a data path passes through a network (E-UTRAN 10, EPC 20). The data path is a communication path for user data. On the other hand, the D2D communication is a communication mode in which a data path set between UEs does not pass through the network.

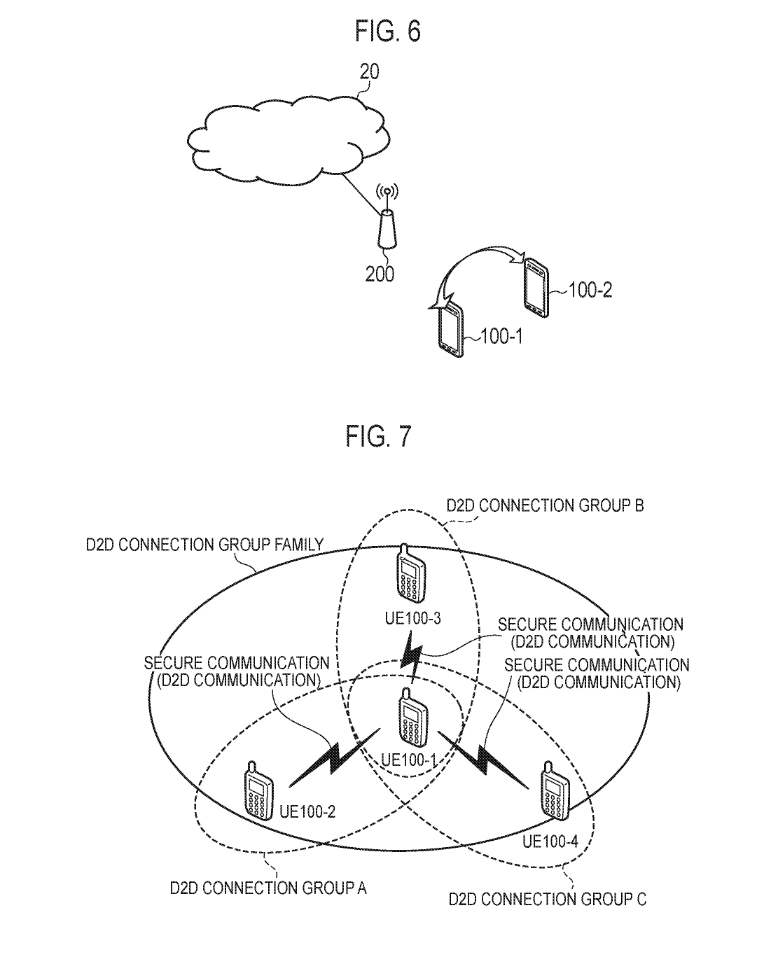

FIG. 6 is a diagram for describing the D2D communication. As shown in FIG. 6, in the D2D communication, a data path does not pass through the eNB 200. A UE 100-1 and a UE 100-2 proximal to each other directly perform radio communication with low transmission power in a cell of the eNB 200. Thus, when the proximal UE 100-1 and UE 100-2 directly perform radio communication with low transmission power, it is possible to reduce a power consumption of the UE 100 and to reduce interference to a neighboring cell, in comparison with in the cellular communication.

(Operating Environment of Mobile Communication System)

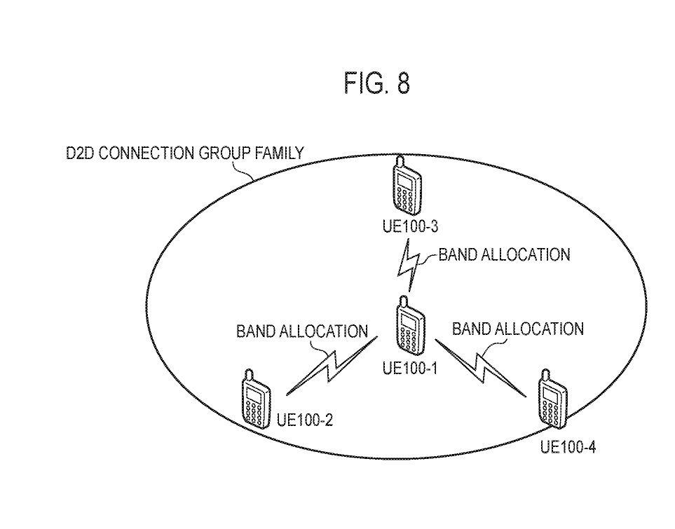

Next, an operating environment of a mobile communication system according to the embodiment will be described using FIGS. 7 and 8. FIGS. 7 and 8 are explanatory diagrams for describing the operating environment of the mobile communication system according to the present embodiment. Specifically, FIG. 7 is an explanatory diagram for describing a state where each UE 100 has performed D2D communication. FIG. 8 is the explanatory diagram for describing a state where a UE100-1 has broadcasted a radio resource allocated to each UE 100 (band allocation).

(1) D2D Communication

As illustrated in FIG. 7, a UE 100-1 individually performs the D2D communication with each of a UE 100-2, a UE 100-3, and a UE 100-4. Therefore, connection to be used for transmitting and receiving user data in the D2D communication (connection for user data) has been established between the UE 100-1 and the UE 100-2. Accordingly, between the UE 100-1 and the UE 100-2, transmission and reception of the user data are performed using the connection for user data. In other words, the UE 100-1 and the UE 100-2 constitute a D2D connection group A. Similarly, connection for user data is established in each of between the UE 100-1 and the UE 100-3, and between the UE 100-1 and the UE 100-4. Therefore, the UE 100-1 and the UE 100-3 constitute a D2D connection group B, and the UE 100-1 and the UE 100-4 constitute a D2D connection group C.

As illustrated in FIG. 7, the UE 100-1, the UE100-2, the UE 100-3, and the UE 100-4 constitute one D2D connection group family, each of the UE 100-2, the UE 100-3, and the UE 100-4 performing D2D communication with the UE 100-1. In other words, the D2D connection group family is constituted by the D2D connection group A, the D2D connection B, and the D2D connection C.

According to the present embodiment, the UE 100-1 individually performs secure communication with each of the UE 100-2, the UE 100-3, and the UE 100-4. Therefore, contents of the user data to be transmitted and received between the UE 100-1 and the UE 100-2 are not known by the other UEs 100 (UE 100-3 and UE 100-4) that have performed communication with the common UE 100-1.

Meanwhile, the UE 100-2 performs the D2D communication with the UE 100-1, but does not perform D2D communication with each of the UE 100-3 and the UE 100-4. Therefore, connection for user data is not established in each of between the UE 100-2 and the UE 100-3 and between the UE 100-2 and the UE 100-3. Similarly, connection for user data is not established between the UE 100-3 and the UE 100-4.

(2) Radio Resource Allocation

According to the present embodiment, the UE 100-1 performs allocation of radio resources in the D2D connection group family. The UE 100-1 allocates mutually different radio resources in order to transmit user data. According to the present embodiment, the UE 100-1 performs allocation of a radio resource for each of the D2D connection groups. That is, the UE 100-1 is a scheduling UE 100 that performs the allocation of radio resources in the D2D connection group family.

As illustrated in FIG. 8, the UE 100-1 uses a radio resource that has been shared with the respective UEs 100 so as to broadcast the radio resource that has been allocated to each of the D2D connection groups (band allocation). According to the present embodiment, the UE 100-1 broadcasts using the same radio resource. The UE 100-2, the UE 100-3, and the UE 100-4 that constitute the D2D connection group family, receive the band allocations.

The UE 100-1 establishes the connection for user data and also connection for control data with the UE 100-2 in order to broadcast the band allocation. The UE100-1 broadcasts the band allocation using the connection for control data. The UE 100-1 also establishes connection for control data with each of the UE 100-3 and the UE 100-2.

(Outlined Operation of Mobile Communication System)

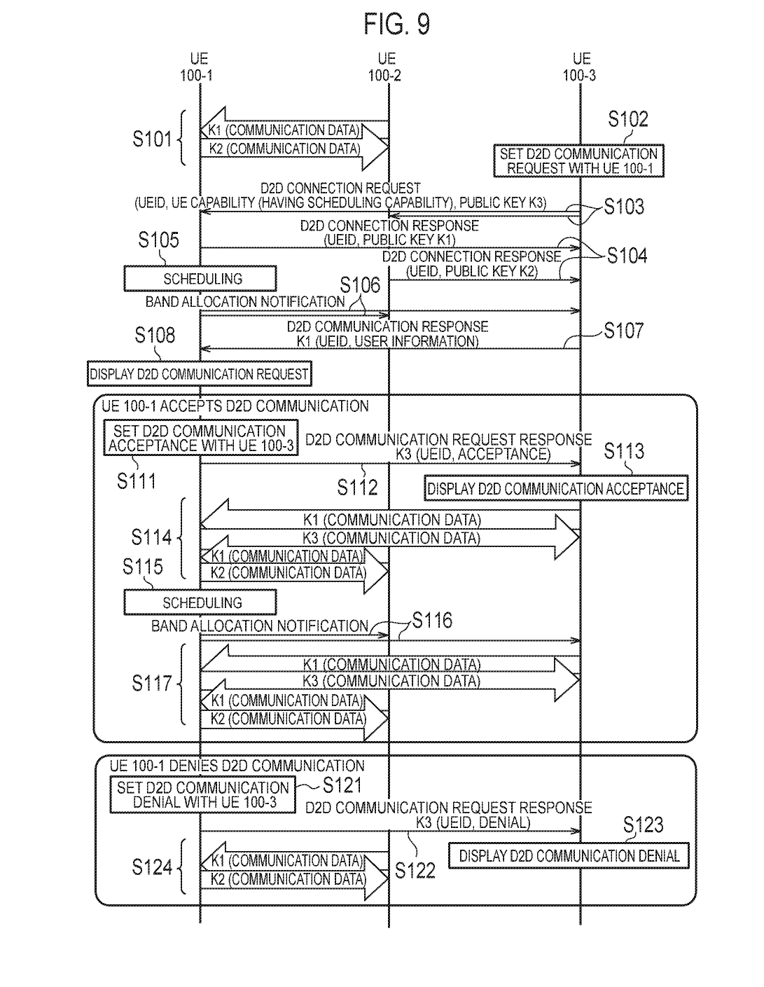

Next, outlined operation of the mobile communication system according to the present embodiment will be described using FIG. 9. FIG. 9 is a sequence diagram illustrating exemplary operation of the mobile communication system according to the present embodiment.

Assuming that the UE 100-1 has individually performed the D2D communication with each of the UE 100-2 and the UE 100-4 and also assuming that the UE 100-3 has not started the D2D communication with the UE 100-1, the description will be given below. The UE 100-1 has been selected as a scheduling UE in the D2D communication individually performed with each of the UE 100-2 and the UE 100-4.

Note that, operation of the UE 100-4 is similar to operation of the UE 100-2. Thus, the description of the UE 100-4 will be omitted.

As illustrated in FIG. 9, the UE 100-1 and the UE 100-2 perform the D2D communication with each other at step S101. Specifically, the UE 100-1 transmits communication data that has been encrypted using a public key K2, to the UE 100-2. The UE 100-2 transmits communication data that has been encrypted using a public key K1, to the UE 100-1.

The UE 100-1 has a secret key K1 for decrypting the data that has been encrypted using the public key K1. The UE 100-1 decrypts the communication data that has been encrypted, using the secret key K1. Accordingly, the UE 100-1 recognizes the communication data from the UE 100-2. Meanwhile, the UE 100-2 has a secret key K2 for decrypting data that has been encrypted using the public key K2. The UE 100-2 decrypts the communication data that has been encrypted, using the secret key K2. Accordingly, the UE 100-2 recognizes the communication data from the UE 100-1.

At step S102, a user of the UE 100-3 performs an operation for performing the D2D communication with the UE 100-1. A predetermined signal is input into a controller of the UE 100-3. Accordingly, the UE 100-3 performs a setting for requesting the D2D communication with the UE 100-1.

At step S103, the UE 100-3 that has performed the setting at step S102, transmits a D2D connection request to the UE 100-1 and the UE 100-2. The UE 100-1 and the UE 100-2 receive the D2D connection request.

The D2D connection request is used for requesting connection establishment between terminals in order to perform the D2D communication. According to the present embodiment, the D2D connection request includes an identifier (UEID) of a source (UE 100-3), information that indicates that the UE 100-3 has scheduling capability (UE Capability), and a public key K3 of the UE 100-3.

At step S104, each of the UE 100-1 and the UE 100-2 transmits a response to the D2D connection request (D2D connection response), to the UE 100-3. The UE 100-3 receives the D2D connection response from each of the UE 100-1 and the UE 100-2.

According to the present embodiment, the D2D connection response includes identifiers (UEID) of a destination (UE 100-1 or UE 100-2) and the source (UE 100-3), and a public key (the public key K1 of the UE 100-1 or the public key K2 of the UE 100-2).

At step S105, the UE 100-1 performs scheduling. The UE 100-1 performs allocation of a radio resource for the D2D communication between the UE 100-1 and the UE 100-2, and also performs allocation of a radio resource for the D2D communication between the UE 100-1 and the UE 100-3. In both of the D2D communication with UE 100-2 and the D2D communication with UE 100-3, the UE 100-1 allocates the radio resources so as to prevent the radio resources to be allocated from overlapping with each other.

At step S106, the UE 100-1 broadcasts the radio resources that have been allocated by the scheduling (band allocations), using the radio resource that has been shared with the respective UEs 100 in the D2D connection group family. Each of the UE 100-2 and the UE 100-3 receives the band allocation.

The band allocation includes information on the radio resource that has been allocated to the UE 100-1 and the UE 100-2 for the D2D communication between the UE 100-1 and the UE 100-2, and also information on the radio resource that has been allocated to the UE 100-1 and the UE 100-3 for the D2D communication between the UE 100-1 and the UE 100-3. Therefore, the UE 100-2 is capable of recognizing the radio resource for transmitting user data of oneself and also the radio resource for transmitting user data of the UE 100-3. Same applies to the UE 100-3.

After that, each of the UEs 100 performs the D2D communication using the band allocation that has been broadcasted at step S106.

At step S107, the UE 100-3 transmits a D2D communication request for requesting the D2D communication, to the UE 100-1 using the band allocation that has been received from the UE 100-1. The UE 100-1 receives the D2D communication request.

The D2D communication request includes the identifier (UEID) of the source (UE 100-3) and user information of the UE 100-3. The D2D communication request has been encrypted using the public key K1.

At step S108, the UE 100-1 displays the D2D communication request from the UE 100-3, on a user interface 120. Specifically, the UE 100-1 decrypts the D2D communication request using the secret key K1 after receiving the D2D communication request from the UE 100-3. The UE 100-1 recognizes the D2D communication request and displays, for example, the user information of the UE 100-3 on the user interface 120.

In a case where the UE 100-1 has determined to accept the D2D communication with the UE 100-3 based on an operation of a user of the UE 100-1 (in a case where processing of step S111 has been performed), processing of step S112 is performed. Meanwhile, in a case where the UE 100-1 has determined to deny the D2D communication with the UE 100-3 based on an operation of the user of the UE 100-1 (in a case where processing of step S121 has been performed), processing of step S122 is performed.

At step S111, the UE 100-1 performs a setting for accepting the D2D communication with the UE 100-3, with a signal input by the operation of the user.

At step S112, the UE 100-1 that has performed the setting of step S111, transmits a response to the D2D communication request (D2D communication request response), to the UE 100-3. The UE 100-3 receives the D2D communication request response.

The D2D communication request response at step S112 includes identifiers (UEID) of a destination (UE 100-3) and a source (UE100-1), and acceptance information that indicates the effect that the D2D communication is accepted. The D2D communication request response has been encrypted using the public key K3.

At step S113, based on the acceptance information, the UE 100-3 displays the effect that the D2D communication with the UE 100-1 has been accepted, on a user interface 120. Specifically, the UE 100-3 decrypts the D2D communication request response using the secret key K3 for decrypting the data that has been encrypted using the public key K3 after receiving the D2D communication request response from the UE 100-1. The UE 100-3 recognizes the D2D communication request response, and displays the effect that the D2D communication with the UE 100-1 has been accepted, on the user interface 120.

At step S114, the UE 100-1 individually performs the D2D communication with each of the UE 100-2 and the UE 100-3. Specifically, the UE 100-1 transmits communication data that has been encrypted using the public key K2, to the UE 100-2. The UE 100-1 transmits communication data that has been encrypted using the public key K3, to the UE 100-3. The UE 100-2 decrypts the communication data using the secret key K2. The UE 100-3 decrypts the communication data using the secret key K3.

Similarly, each of the UE 100-2 and the UE 100-3 transmits communication data using the public key K1. The UE 100-1 decrypts the communication data from each of the UE 100-2 and the UE 100-3 using the secret key K1.

At step S115, like step S105, the UE 100-1 performs the scheduling. The UE 100-1 allocates radio resources both in the D2D communication between the UE 100-1 and the UE 100-2 and in the D2D communication between the UE 100-1 and the UE 100-3 so as to prevent the radio resources to be allocated from overlapping with each other.

At step S116, like step S106, the UE 100-1 broadcasts the radio resources that have been newly allocated by the scheduling (band allocations), using the radio resource that has been shared with the respective UEs 100.

After that, each of the UEs 100 performs the D2D communication using the band allocation that has been broadcasted at step S116.

At step S117, like step S114, the UE 100-1 individually performs the D2D communication with each of the UE 100-2 and the UE 100-3.

Meanwhile, at step S121, the UE 100-1 performs a setting for denying the D2D communication with the UE 100-3 with a signal input by an operation of the user.

At step S122, the UE 100-1 that has performed the setting at step S121, transmits a response to a D2D communication request (D2D communication request response), to the UE 100-3. The UE 100-3 receives the D2D communication request response.

The D2D communication request response at step S122 includes the identifiers (UEID) of the destination (UE 100-3), the source (UE 100-1) and denial information that indicates the effect that the D2D communication is denied. The D2D communication request response has been encrypted using the public key K3.

At step S123, based on the denial information, the UE 100-3 displays the effect that the D2D communication with the UE 100-1 has been denied, on the user interface 120. Specifically, the UE 100-3 decrypts the D2D communication request response using the secret key K3 after receiving the D2D communication request response from the UE 100-1. The UE 100-3 recognizes the D2D communication request response, and displays the effect that the D2D communication with the UE 100-1 has been denied, on the user interface 120.

At step S124, like step S101, the UE 100-1 and the UE 100-2 perform the D2D communication with each other.

Note that, the UE 100-1 individually performs the D2D communication with the UE 100-4 in addition to the UE 100-2. Thus, like steps S105 and S106, the UE 100-1 performs scheduling of radio resources, and broadcasts the radio resources to be allocated in the individual D2D communication so as to prevent the radio resources from overlapping with each other, using the radio resource that has been shared with the respective UEs 100 in the D2D connection group family.

(Outlined Operation of Mobile Communication System According to First Modification)

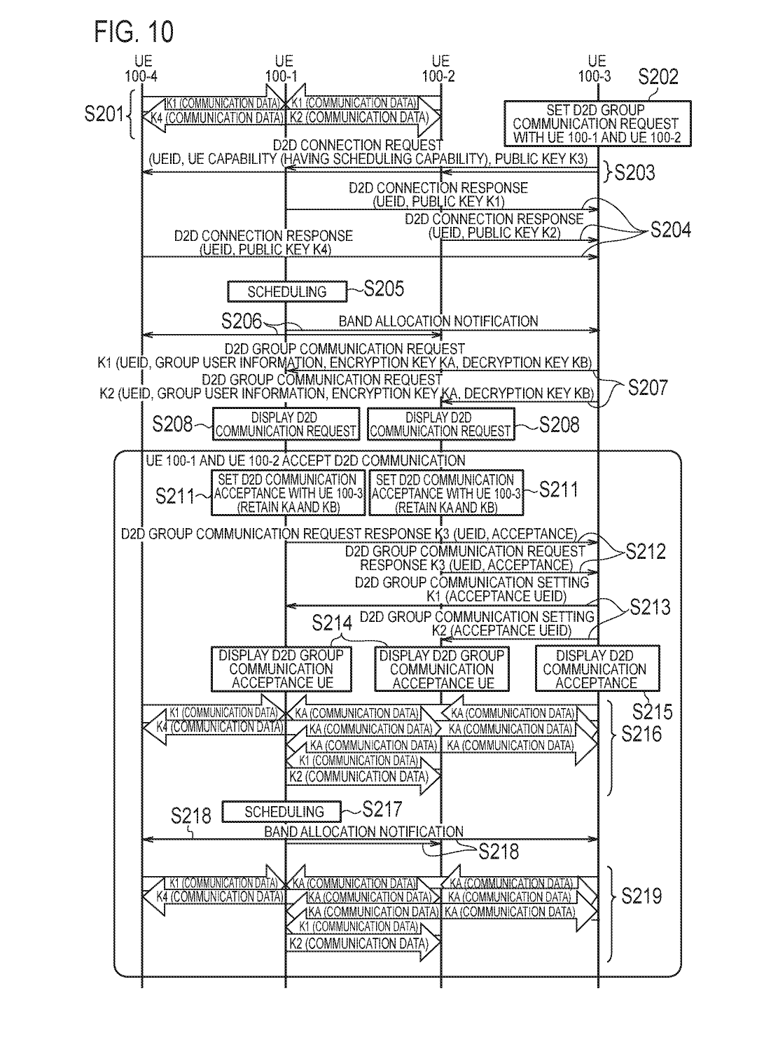

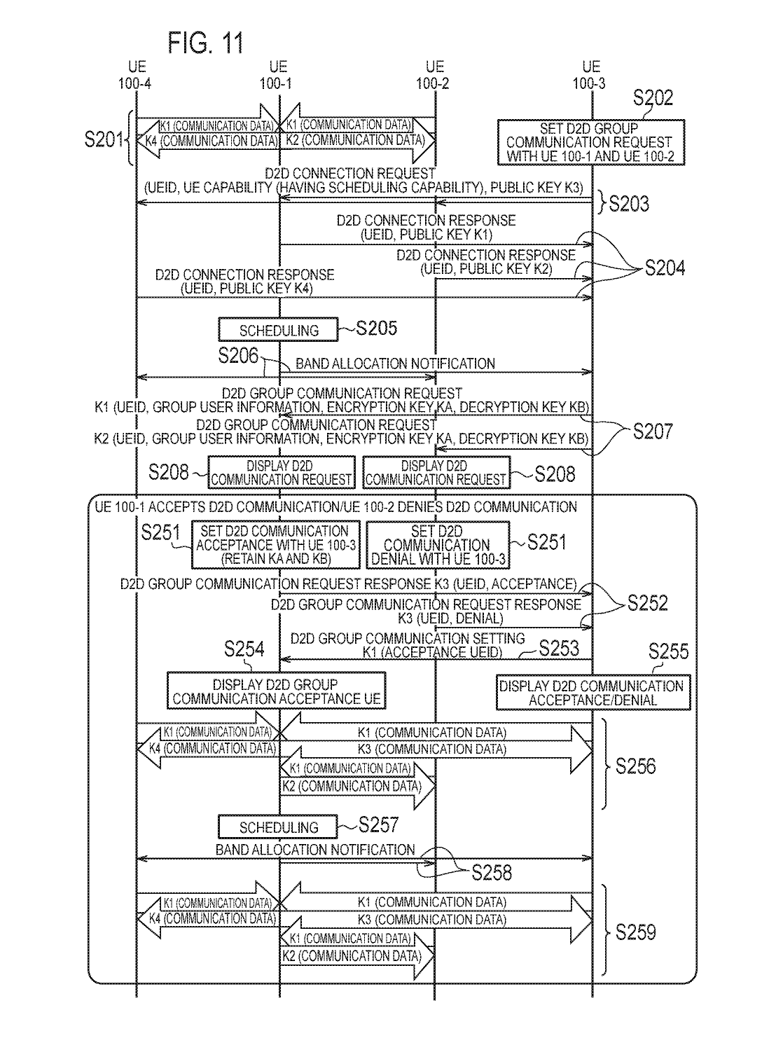

Next, outlined operation of a mobile communication system according to a first modification of the present embodiment, will be described using FIGS. 10 and 11. FIGS. 10 and 11 are sequence diagrams illustrating examples of the operation of the mobile communication system according to the first modification of the present embodiment.

According to the above embodiment, the UE 100-3 requests the D2D communication only with respect to the UE 100-1. According to the present modification, a UE 100-3 request D2D communication with respect to each of UE 100-1 and the UE 100-2. That is, the UE 100-3 requests D2D group communication.

Note that parts different from the above embodiment will be mainly described. Descriptions of parts similar to the above embodiment will be appropriately omitted. In particular, according to the present modification, since a UE 100-4 performs operation similar to that of the UE 100-2, parts different from the UE 100-2 will be mainly described.

As illustrated in FIG. 10, steps S201 to S206 correspond to steps S101 to S106, respectively.

Note that the UE 100-4 performs encryption and decryption of communication data using a public key K4 and a secret key K4.

At step S207, the UE 100-3 transmits a D2D group communication request to each of the UE 100-1 and the UE 100-2.

The D2D group communication request includes an identifier (UEID) of a source (UE 100-3), group user information, an encryption key KA, and a decryption key KB.

The group user information includes information that indicates target terminals (UE 100-1 and UE 100-2) to which the UE 100-3 requests the D2D group communication (for example, identifier). The encryption key KA is used for encrypting the communication data in a case where the group communication is performed. The decryption key is used for decrypting the communication data that has been encrypted with the encryption key KA.

At step S208, like step S108, each of the UE 100-1 and the UE 100-2 displays the D2D communication request from the UE 100-3, on the user interface 120. At step S208, unlike step S108, the effect that the D2D communication has been requested, and the configuration UE 100 that constitute the D2D connection group may be displayed on the user interface 120.

Here, based on each of operations of a user of the UE 100-1 and a user of the UE 100-2, in a case where each of the UE 100-1 and the UE 100-2 determines that the D2D communication with the UE 100-3 is accepted (in a case where processing of step S211 has been performed), processing of step S212 is performed. Meanwhile, in a case that the UE 100-1 determines that the D2D communication with the UE 100-3 is accepted and in a case where the UE 100-2 determines that the D2D communication with the UE 100-3 is denied (in a case where processing of step S251 has been performed), processing of step S252 is performed.

Note that, in a case where each of the UE 100-1 and the UE 100-2 determines that the D2D communication with the UE 100-3 is denied, the same series of processing as steps S121 to S124 is performed.

At step S211, the UE 100-1 performs a setting for accepting the D2D communication with the UE 100-3, with a signal input by the operation of the user. The UE 100-1 retains (stores) the encryption key KA and the decryption key KB by the setting. The UE 100-2 performs the same processing as the UE 100-1.

At step S212, the UE 100-1 that has performed the setting of step S211, transmits a response to the D2D group communication request (D2D group communication request response), to the UE 100-3. The UE 100-3 receives the D2D group communication request response. The D2D group communication request response corresponds to the D2D communication request response at step S112. The UE 100-2 performs the same processing as the UE 100-1.

At step S213, the UE 100-3 transmits D2D group setting information to each of the UE 100-1 and the UE 100-2.

The D2D group setting information includes identifiers (acceptance UEID) that indicate the UEs 100 that have accepted so as to perform the D2D communication in the D2D connection group including the UE 100-3. At step S213, the acceptance UEID includes the identifiers of the UE 100-1 and the UE 100-2.

At step S214, each of the UE 100-1 and the UE 100-2 that have received the D2D group setting information, displays, on the user interface 120, information indicating that the UE 100 has accepted the D2D group communication (UE 100-1 or UE 100-2). Each of the UE 100-1 and the UE 100-2 may display the UE 100-3 in addition to the UE 100 that has accepted the D2D group communication. That is, information that indicates all the UEs 100 that perform the D2D group communication except oneself, may be displayed on the user interface 120.

At step S215, like step S113, the UE 100-3 displays the effect that the D2D communication has been accepted, on the interface 120. The UE 100-3 may display information that indicates the UEs 100 that have accepted (UE 100-1 and UE 100-2), on the user interface 120.

At step S216, the UE 100-1, the UE100-2, and the UE 100-3 perform the group communication using the band allocations that have been broadcasted at step S206. Each of the UE 100-1, the UE 100-2, and the UE100-3 encrypt communication data using the encryption key KA, and decrypt the communication data using the decryption key KB. The UE 100-1 and the UE 100-2 continue individual D2D communication, different from the group communication, with each other.

Like step S201, the UE 100-1 and the UE 100-4 perform individual D2D communication with each other using the band allocation that has been broadcasted at step S206.

At step S217, like step S115, the UE 100-1 performs the scheduling. The UE 100-1 allocates radio resources in the group communication, the D2D communication with the UE 100-2, the D2D communication with the UE 100-4 so as to prevent the radio resources to be allocated from overlapping with each other.

At step S218, like step S116, the UE 100-1 broadcasts the radio resources that have been newly allocated by the scheduling (band allocations), using the radio resource that has been shared with the respective UEs 100.

At step S219, like step S216, each of the UEs 100 performs the D2D communication.

Next, a case where the user of the UE 100-1 accepts the D2D communication with the UE 100-3 and the user of the UE 100-2 denies the D2D communication with the UE 100-3, will be described.

As illustrated in FIG. 11, at step S251, the UE 100-1 performs a setting for accepting the D2D communication with the UE 100-3, with a signal input by an operation of the user.

Meanwhile, the UE 100-2 performs a setting for denying the D2D communication with the UE 100-3, with a signal input by an operation of the user. According to the setting, the UE 100-1 does not retain (store) the encryption key KA and the decryption key KB.

At step S252, each of the UE 100-1 and the UE 100-2 that has performed the settings of step S251, transmits a D2D group communication request response, to the UE 100-3.

The D2D group communication request response from the UE 100-1 includes information indicating the effect that the D2D communication with the UE 100-3 is accepted. In contrast, the D2D group communication request response from the UE 100-2 includes information indicating the effect that the D2D communication with the UE 100-3 is denied.

At step S253, the UE 100-3 transmits D2D group setting information to the UE 100-1. The UE 100-3 does not transmit the D2D group setting information to the UE 100-2 that has denied the D2D communication.

At step S254, the UE 100-1 that has received the D2D group setting information, displays, on the user interface 120, information indicating the UE 100 that has accepted the D2D group communication. The U 100 may display, on the user interface 120, information indicating that the D2D communication with only the UE 100-3 is performed, since there is no UE 100 that has accepted the D2D communication other than oneself.

At step S255, the user interface 120 displays the information indicating the UE 100 (UE 100-1) that has accepted the D2D communication, and the information indicating the UE 100 (UE 100-2) that has denied the D2D communication.

At step S256, the UE 100-1 individually performs the D2D communication with each of the UE 100-2, the UE 100-3, and the UE 100-4.

Note that, the UE 100-1 and the UE 100-3 may perform transmission and reception of communication data using the encryption key KA and the decryption key KB. Since the UE 100-2 has received the encryption key KA and the decryption key KB once, communication data may be encrypted using the public key K1 and the public key K2. In a case where D2D group communication is performed among three UEs 100 or more, the group communication may be performed using a new encryption key and a new decryption key.

At step S257, like step S115, the UE 100-1 performs the scheduling.

At step S258, like step S116, the UE 100-1 broadcasts radio resources (band allocations) that have been newly allocated by the scheduling, using the radio resource that has been shared with the respective UEs 100.

Step S259 corresponds to step S256. At step S258, the UE 100-1 individually performs the D2D communication with each of the UE 100-2, the UE 100-3, and the UE 100-4, using the radio resources that have been newly allocated at step S258.

(Outlined Operation of Mobile Communication System According to Second Modification)

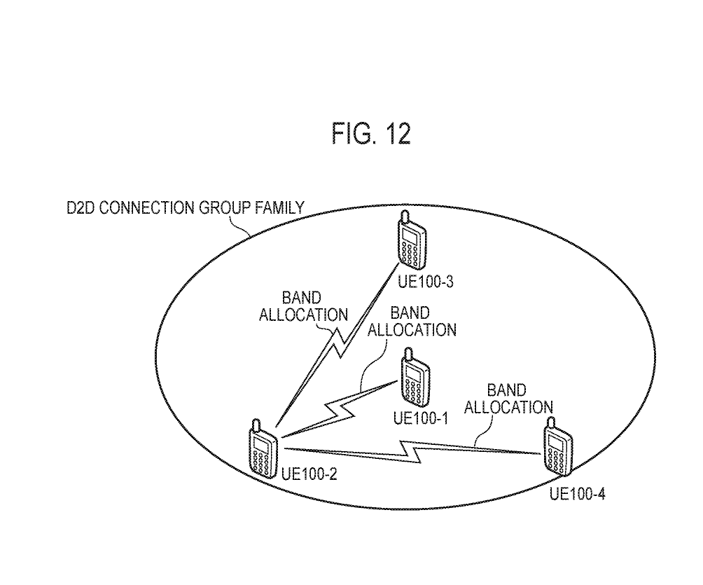

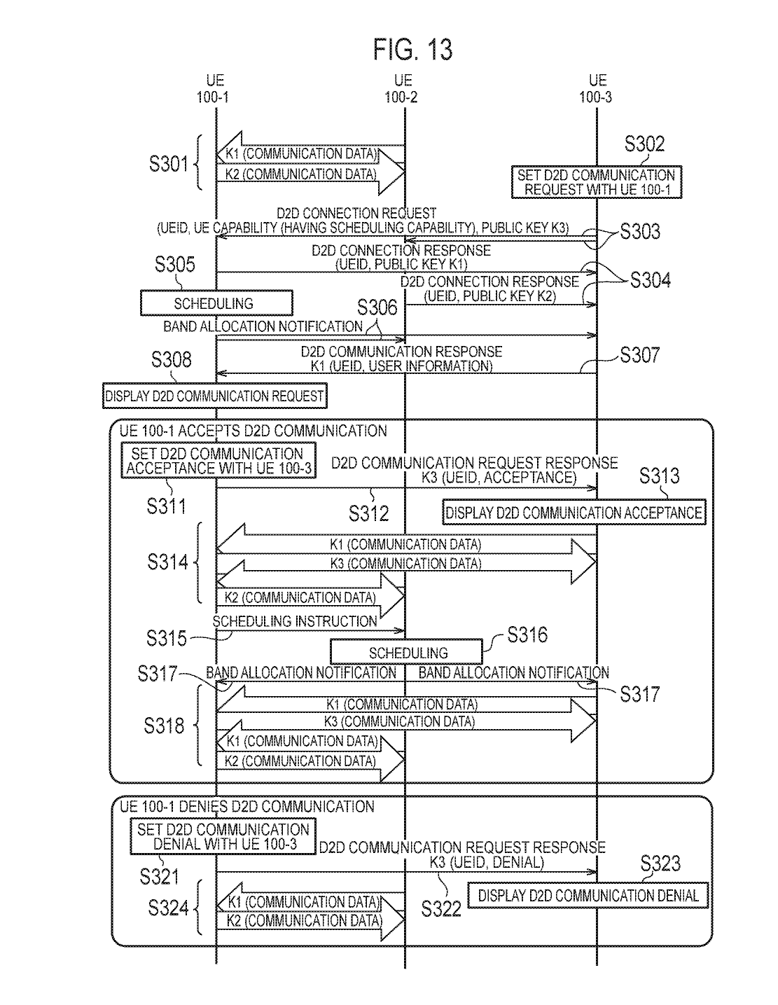

Next, outlined operation of a mobile communication system according to a second modification of the present embodiment, will be described using FIGS. 12 and 13. FIG. 12 is an explanatory diagram for describing a state where a UE 100-2 according to the second modification has broadcasted a radio resource that has been allocated to each of UEs 100 (band allocation). FIG. 13 is a sequence diagram illustrating exemplary operation of the mobile communication system according to the second modification of the present embodiment.

According to the above embodiment, the UE 100-1 broadcasts the band allocation to each of the UEs 100. According to the present modification, the UE 100-2 broadcasts a band allocation.

Note that parts different from the above embodiment will be mainly described. Descriptions of parts similar to the above embodiment will be appropriately omitted. In particular, operation of a UE 100-4 is similar to that of the above UE 100-4. Description of the UE 100-4 will be omitted.

According to the present modification, the UE 100-2 performs allocation of radio resources in a D2D connection group family. The UE 100-2 allocates the mutually different radio resources for transmitting user data. According to the present embodiment, the UE 100-2 is a scheduling UE 100.

As illustrated in FIG. 12, the UE 100-2 broadcasts the radio resources that have been allocated (band allocations), using a radio resource that has been shared with respective UEs 100. A UE 100-1, a UE 100-3, and a UE 100-4 that constitute the D2D connection group family, receive the band allocations.

The UE 100-2 establishes connection for control data with the UE 100-1 in addition to connection for user data in order to broadcast the band allocations. Furthermore, the UE 100-2 establishes connection for control data with the UE 100-3 that does not perform transmission and reception of user data. Similarly, the UE 100-2 establishes connection for control data with the UE 100-4.

Next, an exemplary sequence of the mobile communication system according to the present embodiment, will be described.

As illustrated in FIG. 13, steps S301 to S308 correspond to steps S101 to S108, respectively.

In a case where the UE 100-1 determines that D2D communication with the UE 100-3 is accepted, steps S311 to S314 correspond to steps S111 to S114, respectively.

At step S315, the UE 100-1 transmits a scheduling instruction for performing scheduling for the D2D communication in the D2D connection group family, to the UE 100-2. The UE 100-2 receives the scheduling instruction.

The UE 100-1 selects the scheduling UE 100 from the plurality of UEs 100 that constitutes the D2D connection group family.

The UE 100-1 determines to select the scheduling UE 100 in a case where a predetermined condition has been satisfied. For example, any of (a) a case where remaining battery power of the UE 100-1 becomes below a threshold value, (b) a case where a processing load of the UE 100-1 becomes a threshold value or more, (c) a case where a predetermined period of time has passed since the UE 100-1 has been selected by the scheduling UE 100, is satisfied, the UE 100-1 selects the scheduling UE 100.

The UE 100-1 may determine to select the scheduling UE 100 in accordance with states of the plurality of UEs 100 that constitutes the D2D connection group family (for example, a processing load) in addition to a state of the UE 100-1 itself.

In a case where the UE 100-1 determines to select the scheduling UE 100, as a reference for determining to select which UE 100 is selected from the plurality of UEs 100 that constitutes the D2D connection group family, by at least any of (a) whether or not there is scheduling capability, (b) remaining battery power, (c) a processing load, (d) a radio environment with other UEs 100, the UE 100-1 may determine the scheduling UE 100.

In order to select the scheduling UE 100, the UE 100-1 may periodically or aperiodically receive notification of necessary information (for example, capability information of the UE 100, a traffic volume, information indicating a radio propagation environment) from the plurality of UEs 100 that constitutes the D2D connection group family.

The UE 100-1 notifies the UE 100 (UE 100-2) that has been selected, of the scheduling instruction in a case where the scheduling UE 100 has been selected.

The scheduling instruction includes information indicating that the selected UE 100 is the scheduling UE 100, and respective identifiers of the plurality of UEs 100 that constitutes the D2D connection group family.

In a case where the scheduling instruction has been received, the UE 100-2 may transmit a response indicating whether the UE 100-2 accepts so as to be the scheduling UE 100. For example, in a case where there is no scheduling capability or in a case where the D2D communication is completed (or to be completed), the UE 100-2 may transmit, to the UE 100-1, a response indicating that the UE 100-2 does not accept so as to be the scheduling UE 100. In this case, the UE 100-1 may newly select a scheduling UE 100.

The UE 100-1 may broadcast information indicating that the scheduling UE 100 has been newly selected, to the UE 100-3 using the radio resource that has been shared with respective UEs 100.

At step S316, like step S115, the UE 100-2 performs the scheduling.

At step S317, like step S116, the UE 100-2 broadcasts radio resources that have been newly allocated by the scheduling (band allocations), using the radio resource that has been shared with respective UEs 100.

The UE 100-2 may establish the connection for control data with the UE 100-3 before the broadcasting.

Step S318 corresponds to step S314. The UE 100-1 individually performs the D2D communication using the radio resources allocated by the UE 100-2.

Steps S321 to S324 correspond to steps S121 to S124, respectively. Note that, in a case that the UE 100-1 determines that the D2D communication with the UE 100-3 is denied, the UE 100-1 may transmit a scheduling instruction to the UE 100-2 like the above step S315. Alternatively, since the D2D communication with the UE 100-3 is not performed and a processing load of the UE 100-1 does not increase, the UE 100-1 need not transmit the scheduling instruction to the UE 100-2.

### Summary of Embodiments

According to the present embodiment, the UE 100-2 establishes the connection for user data between the UE 100-2 and the UE 100-1 without establishing the connection for user data in each of between the UE 100-2 and the UE 100-3 and between the UE 100-2 and the UE 100-4. Same applies to the UE 100-3 and the UE 100-4. In this case, as the scheduling UE 100, the UE 100-1 has been selected from the plurality of UEs 100 that constitutes the D2D connection group family, the UE 100-1 allocating mutually different radio resources to each of the plurality of UEs 100 that constitutes the D2D connection group family in order to transmit data including the user data. The UE 100-1 broadcasts the band allocations indicating the radio resources that have been allocated to the respective plurality of UEs 100 that constitutes the D2D connection group family, using the radio resource that has been shared with the respective UEs 100. Accordingly, the UE 100-1 can notify the plurality of UEs 100 included in the different D2D connection groups, of the band allocations at once. Therefore, since a large number of radio resources are not required to be used in order to notify the band allocations, radio resources can be effectively used.

According to the second modification, the scheduling UE 100 is selected from the UE 100-2, the UE 100-3, and the UE 100-4, except the UE 100-1. The UE 100-2 that has been selected, establishes the connection for control data for broadcasting the band allocation in each of between the UE 100-2 and the UE 100-3, and between the UE 100-2 and the UE 100-4, except the UE 100-1. Accordingly, each of the UE 100-3 and the UE 100-4 securely receives the band allocations using the connection from the UE 100-1.

According to the second modification, the UE 100-3 may notify the UE 100-1 of UE capability regarding the scheduling capability (UE Capability). The scheduling UE 100 may be selected based on the UE capability. Accordingly, the scheduling instruction can be prevented from transmitting to the UEs 100 that have no scheduling capability. Radio resources can be effectively used.

According to the second modification, in a case where the predetermined condition is satisfied, the scheduling UE 100 is newly selected from the plurality of UEs 100 that constitutes the D2D connection group family. Accordingly, a load caused by the scheduling can be prevented from deviating to one UE 100.

According to the second modification, the predetermined condition is that the remaining battery power of the UE 100-1 becomes below the threshold value, the UE 100-1 being the scheduling UE 100. Accordingly, the allocation of the radio resources can be prevented from not being performed in a case where the remaining battery power of the scheduling UE 100 runs out.

According to the present embodiment, each of the UE 100-1, the UE 100-2, the UE 100-3, and the UE 100-4 transmits and receives user data, based on the band allocation, using the encryption key and the decryption key (secret key or decryption key). Therefore, even when the band allocation is broadcasted by the same radio resource, other UEs 100 cannot grasp the user data. Therefore, each of the UEs 100 that constitute the D2D connection group family securely performs the D2D communication.

### Other Embodiments

The present invention has been described in the above embodiments. The descriptions and the drawings included in a part of this disclosure do not limit the present invention. The disclosure clarifies various alternative embodiments, examples, and investment techniques for persons skilled in the art.

For example, according to the above embodiment and the above second modification, the UE 100-3 may transmit a D2D connection request including the identifier of the UE 100 that requests the D2D communication (specifically, UE 100-1). Accordingly, since the UE 100-2 recognizes that the UE 100-2 is not a target to be requested for the D2D communication, transmission of the D2D connection response to the UE 100-3 can be omitted. That is, the UE 100-2 can omit the processing of step S104 and the processing of step S304.

According to the above embodiment, the UE 100-1 broadcasts the band allocations using the radio resource that has been shared with the respective UEs 100, but the present invention is not limited to this. The UE 100-1 may transmit, for example, a band allocation to a UE 100 that has not received the broadcasted band allocation, using radio resources allocated dedicatedly to the respective UEs 100 in addition to the radio resource that has been shared.

According to the above first modification, at steps S216 and S219, the UE 100-1 and the UE 100-2 continue the individual D2D communication with each other in addition to the group communication. However, the individual D2D communication may be terminated. In this case, since the UE 100-1 has a relationship with the UE 100-2 and the UE 100-3 in the group communication and a relationship with the UE 100-4 in the D2D communication, the UE 100-1 has performed the individual D2D communication.

According to the above embodiment and the above modifications, the UE 100-1 and the UE 100-2 that transmit and receive the user data, perform the scheduling so as to broadcast the band allocations. The present invention is not limited to this. A UE 100 that has established no connection for user data and established only connection for control data with the other UEs 100, may perform the scheduling. The UE 100 that has performed the scheduling may broadcast the band allocations with the connection for control data using the radio resource that has been shared with the respective UEs 100 that constitute the D2D connection group family.

According to the above embodiment and the above modifications, as the encryption key and the decryption key, the D2D communication may be performed using code encoding.

In the above embodiment, one example that the present invention is applied to the LTE system has been described; however, the present invention is not limited to apply to the LTE system and may also be applied to systems, other than the LTE system, as well as the LTE system.

In addition, the entire content of JP Patent Application No. 2013-144023 (filed on Jul. 9, 2013) is incorporated in the present specification by reference.

### INDUSTRIAL APPLICABILITY

As described above, the mobile communication system and the user terminal according to the present invention are useful in a mobile communication field since it is possible to inhibit occurrence of interference in a case where a user terminal individually performs the D2D communication with each of a plurality of other user terminals.

1. A mobile communication system comprising a user terminal and a plurality of other user terminals different from the user terminal and supporting D2D communication that is direct terminal-to-terminal communication without passing through a network,
wherein in a case where each of the plurality of other user terminals establishes connection for user data with the user terminal for transmitting and receiving user data through the D2D communication without establishing the connection for user data with each of the plurality of other user terminals, a scheduling terminal is selected from the user terminal and the plurality of other user terminals, the scheduling terminal allocating, to each of the user terminal and the plurality of other user terminals, a mutually different radio resource in order to transmit data including the user data, and
the scheduling terminal broadcasts scheduling information that indicates the radio resource allocated to each of the user terminal and the plurality of other user terminals, using a radio resource that has been shared with the plurality of other terminals.

2. The mobile communication system according to claim 1,
wherein the scheduling terminal is selected from the plurality of other user terminals, and
the scheduling terminal establishes connection for broadcasting the scheduling information, with each of the plurality of other user terminals except the scheduling terminal.

3. The mobile communication system according to claim 2,
wherein each of the plurality of other user terminals transmits, to the user terminal, capability information on scheduling capability for allocating the radio resource for the D2D communication, and
the scheduling terminal is selected based on the capability information.

4. The mobile communication system according to claim 1,
wherein the scheduling terminal is newly selected from the user terminal and the plurality of other user terminals in a case where a predetermined condition is satisfied.

5. The mobile communication system according to claim 4,
wherein the predetermined condition is that remaining battery power of the scheduling terminal becomes below a threshold value.

6. The mobile communication system according to claim 1,
wherein each of the plurality of other user terminals transmits and receives the user data, based on the scheduling information, using an encryption key for encrypting the user data and a decryption key for decrypting the user data that has been encrypted using the encryption key.

7. A user terminal in a mobile communication system comprising the user terminal and a plurality of other user terminals different from the user terminal and supporting D2D communication that is direct terminal-to-terminal communication without passing through a network, the user terminal comprising:
a controller configured to allocate, to each of the user terminal and the plurality of other user terminals, a mutually different radio resource in order to transmit data including user data in a case where each of the plurality of other user terminals establishes connection for user data with the user terminal for transmitting and receiving the user data through the D2D communication without establishing the connection for user data with each of the plurality of other user terminals; and
a transmitter configured to broadcast scheduling information indicating the radio resource allocated to each of the plurality of other user terminals, using a radio resource that has been shared with the plurality of other user terminals.

8. A user terminal in a mobile communication system comprising a user terminal, a different user terminal that is a communicating target of the user terminal, and a plurality of other user terminals different from the user terminal and the different user terminal, and supporting D2D communication that is direct terminal-to terminal communication without passing through a network, the user terminal comprising:
a controller configured to allocate, to each of the user terminal, the different user terminal, and the plurality of other user terminals, a mutually different radio resource in order to transmit data including user data, in a case where the user terminal establishes connection for user data with the different user terminal for transmitting and receiving the user data through the D2D communication without establishing the connection for user data with each of the plurality of other terminals, and
a transmitter configured to broadcast scheduling information indicating the radio resource allocated to each of the different user terminal and the plurality of other user terminals using a radio resource that has been shared with the different user terminal and the plurality of other user terminals.
